(19) United States
(12) Patent Application Publication
(10) Pub. No.: US 2025/0259385 A1
(43) Pub. Date: Aug. 14, 2025

(54) CONTACT PROCESSING METHOD AND SYSTEM FOR VIRTUAL HAND FORCE INTERACTION

(71) Applicants: BEIHANG UNIVERSITY, Beijing (CN); Peng Cheng Laboratory, Shenzhen, Guangdong Province (CN)

(72) Inventors: Dangxiao WANG, Beijing (CN); Qianqian TONG, Beijing (CN); Wenxuan WEI, Beijing (CN); Yuru ZHANG, Beijing (CN)

(21) Appl. No.: 18/856,837

(22) PCT Filed: Aug. 11, 2022
(86) PCT No.: PCT/CN2022/111749

§ 371 Date: Oct. 14, 2024

(30) Foreign Application Priority Data
Apr. 13, 2022 (CN) 202210384860.4

(51) Int. Cl. G06T 17/00; G06F 3/01; G06F 3/0346; G06T 13/40

(52) U.S. Cl. CPC G06T 17/005; G06F 3/016; G06T 13/40; G06F 3/014; G06F 3/0346; G06T 2210/21

(57) ABSTRACT

A contact processing method and system for virtual hand force interaction is provided. With regard to the structure of a virtual hand, considering of different thicknesses of human finger joints, fingers are represented by cone frustums. A virtual object is constructed by using a sphere-tree model, a cone frustum-sphere contact processing system for force interaction between the virtual hand and the virtual object is provided, and the system can achieve high (up to 1 kHz) contact processing efficiency while implementing stable, non-penetrating, and realistic virtual hand force interaction simulation. An articulated cone frustum is used to simulate a real hand, so that the visualization of the virtual hand is ensured, and a contact constraint between spheres and cone frustums is used to ensure that a side edge of a virtual finger is not penetrated into the virtual object, helping to avoid the issue of visuo-haptic inconsistent.

### CROSS-REFERENCE TO RELATED APPLICATIONS

This patent application is a national stage of International Application No. PCT/CN2022/111749, filed on Aug. 11, 2022, which claims the benefit and priority of Chinese Patent Application No. 202210384860.4 filed with the China National Intellectual Property Administration on Apr. 13, 2022 and entitled as “CONTACT PROCESSING METHOD AND SYSTEM FOR VIRTUAL HAND FORCE INTERACTION”. Both aforementioned applications are incorporated by reference herein in their entireties.

### TECHNICAL FIELD

The present disclosure relates to the technical field of contact force interaction, in particular to a contact processing method and system for virtual hand force interaction.

### BACKGROUND OF THE INVENTION

In order to simulate the interaction experience of manipulating objects with tools, researchers have developed a series of contact processing methods (3-DOF (Degree of Freedom)/6-DOF) and systems for virtual tool force interaction, which has promoted the wide application of desktop force interaction devices, such as Phantom Premium used in dental surgery simulators. In daily life, people usually touch and operate objects directly with their hands. In order to simulate this intuitive way of interaction and enhance the immersion of interaction with the virtual world (such as virtual assembly, virtual surgery, simulation of high-risk working environment, vocational training, entertainment, games, etc.), in addition to developing a force feedback device for virtual hand interaction, such as Dexmo force feedback gloves of Dexta Robotics, a high-fidelity contact processing method and system for virtual hand force interaction are required as support.

Compared with the contact processing method for virtual tool force interaction, the implementation of the contact processing method for virtual hand force interaction is more challenging, mainly because the virtual hand force interaction involves more freedom of operation, diversified operation methods and more contact points/areas, so that the calculation involved in the contact processing method for virtual hand force interaction is more complicated and time-consuming. The contact processing method for virtual hand force interaction mainly needs to solve the following two key problems of: (1) quickly and accurately determining the contact state between a virtual hand and a virtual object; and (2) quickly and accurately calculating an avatar and a contact force of the virtual hand that does not penetrate into the virtual object.

The solution of the above two problems needs to involve a virtual hand model, which is used to describe the three-dimensional shape, freedom of motion and geometric constraints of a palm and multiple fingers of the virtual hand to meet the demands of motion mapping, collision detection, collision response, contact force calculation and graphic rendering. In the geometric modeling of the virtual hand, simplified models (such as a capsule model representing fingers or sampling some points/areas on the surface of the virtual hand model) are usually used to meet the demand for a high updating frequency in force interaction, and these simplified models can also be combined with other geometric models to represent the virtual hand.

Although the contact processing performance of the virtual hand force interaction can be improved to some extent by the existing methods, there will be a problem of inconsistent visual and haptic feedback due to the fact that a graphic hand and a haptic hand are difficult to match in the virtual hand force interaction process, resulting from a great appearance difference between a simplified virtual hand model and a real hand. For example, when the graphic hand is penetrated into a virtual object, the user is unable to feel the force feedback due to failing to carry out effective contact processing. In addition, due to the complexity of the contact constraint model, the existing contact processing methods can only achieve the updating frequency of tens of hertz, which cannot meet the demand for a high updating frequency (for example, 1 kHz) in force interaction.

Therefore, there is an urgent need in this field for a non-penetrating simulation technical scheme that can realize fast and stable force feedback while ensuring the visualization of the virtual hand.

### SUMMARY OF THE INVENTION

An objective of embodiments of the present disclosure is to provide a contact processing method and system for virtual hand force interaction. An articulated cone frustum is used to simulate a real hand, so that the visualization of the virtual hand is ensured, and a contact constraint between spheres and cone frustums is used to ensure that a side edge of a virtual finger is not penetrated into the virtual object, thereby effectively solving the problem in the art of inconsistent visual and haptic feedback due to the fact that a graphic hand and a haptic hand are difficult to match in the interaction process, resulting from a great appearance difference between a simplified virtual hand model and a real hand. In addition, the cone frustum is used to simulate a finger knuckle of a real hand, which reduces the number of contact constraints and can be processed in parallel, thereby effectively solving the problem of low contact processing efficiency in the prior art.

To achieve the above objective, the present disclosure provides the following scheme.

A contact processing method for virtual hand force interaction, including:
simulating a real hand by using an articulated cone frustum to obtain a virtual hand, where the articulated cone frustum includes a plurality of cone frustums, and each of the cone frustums simulates a finger knuckle of the real hand; a metacarpophalangeal joint and two interphalangeal joints each are simulated by a sphere; the virtual hand further includes a plurality of hemispheres, each of the hemispheres is located on a cone frustum simulating a distal finger knuckle, and used to simulate a fingertip of the real hand;
simulating an object by using a sphere-tree model to obtain a virtual object, where the virtual object includes a plurality of numbered spheres;
obtaining a configuration of the real hand of a user;
driving, by using the configuration of the real hand, the virtual hand, which is called a haptic hand;
displaying the haptic hand in a virtual environment to obtain a graphic hand, and displaying the virtual object in the virtual environment;
constructing a cone frustum-sphere contact determination condition:

$${\vert OC \vert}_{j}^{2} - {( \frac{{R}_{j}}{cos α} + {k}_{j} * ( {r}_{1} - {r}_{2} ) + {r}_{2} )}^{2} \leq 0 , j = 1 , 2 , … , M and \\ - \frac{{R}_{j}}{\vert DE \vert} \leq k \leq 1 + \frac{{R}_{j}}{\vert DE \vert} ,$$

where |OC|ⱼ is a distance from a center of a sphere numbered j in the virtual object to a central axis l of a cone frustum in the graphic hand, Rⱼ is a radius of the sphere numbered j in the virtual object, M is a number of spheres to be detected in the virtual object,

$${k}_{j} = \frac{\vec{{C}_{j} E}}{\vec{DE}} ,$$

Cⱼ represents a foot point of a perpendicular from the center of the sphere numbered j in the virtual object to the central axis l, E and D represent centers of upper and lower surfaces of the cone frustum in the graphic hand, respectively, α represents an included angle between a side edge of the cone frustum in the graphic hand and the central axis thereof, r₂ and r₁ represent radii of the upper and lower surfaces of the cone frustum in the graphic hand, respectively;
according to graphic hand configuration, virtual object configuration, and the cone frustum-sphere contact determination condition, obtaining information of a collision sphere in contact with a side edge of a finger of the graphic hand, where the information of the collision sphere includes a collision sphere number, a sphere center coordinate of the collision sphere and a sphere radius of the collision sphere; the collision sphere is a sphere in the virtual object in contact with the graphic hand; the side edge of the finger of the graphic hand is a side edge of a cone frustum simulating a finger knuckle of the finger; the graphic hand configuration is used for graphic display;
with θ_{1g}^{t}, θ_{2g}^{t} and θ_{3g}^{t} representing a metacarpophalangeal joint angle, a proximal interphalangeal joint angle and a distal interphalangeal joint angle of each finger of the graphic hand, respectively, according to the graphic hand configuration and the information of the collision sphere where the graphic hand is in contact with the virtual object, constructing a non-penetration contact constraint between the side edge of the finger of the graphic hand and the virtual object as follows:

$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N ,$$

where N is a number of spheres in the virtual object which are in contact with fingers of the graphic hand; according to the non-penetration contact constraint between the cone frustums and the spheres, performing optimization on three joint angles θ_{1g}^{t}, θ_{2g}^{t} and θ_{3g}^{t} of each finger of the graphic hand as a whole under a non-penetration contact constraint set, and solving to obtain joint angle information of the finger of the graphic hand that is not penetrated into the virtual object;
according to the joint angle information of the finger of the graphic hand and a formula Fᵢ=Gᵢ·n·|P_{ig}−Pᵢₕ|, calculating normal force Fᵢ of an i-th collision sphere in contact with a corresponding virtual finger, where Gᵢ is a 3×3 stiffness matrix, n represents a unit vector of \vec{OᵢPᵢ}, Oᵢ represents a center of the i-th collision sphere, Pᵢ represents a contact point between the i-th collision sphere and a side edge of the virtual finger, and |P_{ig}−Pᵢₕ| is a length of a line segment between a point Pᵢ on the graphic hand and a corresponding position point P′ᵢ on the haptic hand.

In some embodiments, in determining contact between the graphic hand and the virtual object:
the graphic hand configuration is a graphic hand configuration at a previous moment;
a cross-sectional radius of a cone frustum of each finger knuckle of the graphic hand is increased by Δr;
a radius of a hemisphere of each finger joint of the graphic hand is increased by Δr;
a graphic hand obtained by above changes is used to determine the contact between the graphic hand and the virtual object, and a collision sphere obtained according to the cone frustum-sphere contact determination condition and a sphere-sphere contact determination condition is used to construct the non-penetration contact constraint set.

In some embodiments, while constructing the non-penetration contact constraint

$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N$$

for a distal finger knuckle of each finger, the method further includes:
if the collision sphere is in contact with the hemisphere simulating the fingertip, constructing a non-penetration contact constraint between the sphere and the hemisphere: |OC|ᵢ²−(Rᵢ+r₂)²≥0, and adding the contact constraint to the non-penetration contact constraint set for optimizing finger joint angles of the graphic hand.

In some embodiments, after calculating the normal force Fᵢ of the i-th collision sphere in contact with the corresponding virtual finger according to the formula Fᵢ=Gᵢ·n·|P_{ig}−Pᵢₕ|, the method further includes:
calculating a friction force in a sliding process of the virtual hand by using a formula fᵢ=u·nᵢ·|Fᵢ|, where fᵢ represents a friction force at the i-th collision sphere, u represents a dynamic friction coefficient, and nᵢ is a normal vector of a relative motion between the i-th collision sphere and the virtual finger.

A contact processing system for virtual hand force interaction, including:
a virtual hand construction module, configured to:
simulate a real hand by using an articulated cone frustum to obtain a virtual hand, where the virtual hand includes a plurality of cone frustums, each of the cone frustums simulates a finger knuckle of the real hand; a metacarpophalangeal joint and two interphalangeal joints each are simulated by a sphere; the virtual hand further includes a plurality of hemispheres, each of the hemispheres is located on a cone frustum simulating a distal finger knuckle, and used to simulate a fingertip of the real hand;
simulate an object by using a sphere-tree model to obtain a virtual object, where the virtual object includes a plurality of numbered spheres;
obtain a configuration of the real hand of a user;
drive, by using the configuration of the real hand, the virtual hand, which is called a haptic hand; and
display the haptic hand in a virtual environment to obtain a graphic hand, and display the virtual object in the virtual environment;
a cone frustum-sphere collision detection module, configured to:
construct a cone frustum-sphere contact determination condition:

$${\vert OC \vert}_{j}^{2} - {( \frac{{R}_{j}}{cos α} + {k}_{j} * ( {r}_{1} - {r}_{2} ) + {r}_{2} )}^{2} \leq 0 , j = 1 , 2 , … , M and \\ - \frac{{R}_{j}}{\vert DE \vert} \leq k \leq 1 + \frac{{R}_{j}}{\vert DE \vert} ,$$

where |OC|ⱼ is a distance from a center of a sphere numbered j in the virtual object to a central axis l of a cone frustum in the graphic hand, Rⱼ is a radius of the sphere numbered j in the virtual object, M is a number of spheres to be detected in the virtual object,

$${k}_{j} = \frac{\vec{{C}_{j} E}}{\vec{DE}} ,$$

Cⱼ represents a foot point of a perpendicular from the center of the sphere numbered j in the virtual object to the central axis l, E and D represent centers of upper and lower surfaces of the cone frustum in the graphic hand, respectively, α represents an included angle between a side edge of the cone frustum in the graphic hand and the central axis thereof, r₂ and r₁ represent radii of the upper and lower surfaces of the cone frustum in the graphic hand, respectively; and
according to graphic hand configuration, virtual object configuration, and the cone frustum-sphere contact determination condition, obtain information of a collision sphere in contact with a side edge of a finger of the graphic hand, where the information of the collision sphere includes a collision sphere number, a sphere center coordinate of the collision sphere and a sphere radius of the collision sphere; the collision sphere is a sphere in the virtual object in contact with the graphic hand; the side edge of the finger of the graphic hand is a side edge of a cone frustum simulating a finger knuckle of the finger; the graphic hand configuration is used for graphic display;
a cone frustum-sphere collision response module, configured to:
with θ_{1g}^{t}, θ_{2g}^{t} and θ_{3g}^{t} representing a metacarpophalangeal joint angle, a proximal interphalangeal joint angle and a distal interphalangeal joint angle of each finger of the graphic hand, respectively, according to the graphic hand configuration and the information of the collision sphere where the graphic hand is in contact with the virtual object, construct a non-penetration contact constraint between the side edge of the finger of the graphic hand and the virtual object as follows:

$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N ,$$

where N is a number of spheres in the virtual object which are in contact with virtual fingers of the graphic hand; according to the non-penetration contact constraint between the cone frustums and the spheres, perform optimization on three joint angles θ_{1g}^{t}, θ_{2g}^{t} and θ_{3g}^{t} of each finger of the graphic hand as a whole under a non-penetration contact constraint set, and solve to obtain joint angle information of the finger of the graphic hand that is not penetrated into the virtual object; and
a contact force calculation module, configured to:
according to the joint angle information of the finger of the graphic hand and a formula Fᵢ=Gᵢ·n·|P_{ig}−Pᵢₕ|, calculate normal force Fᵢ of an i-th collision sphere in contact with a corresponding virtual finger, where Gᵢ is a 3×3 stiffness matrix, n represents a unit vector of \vec{OᵢPᵢ}, Oᵢ represents a center of the i-th collision sphere, Pᵢ represents a contact point between the i-th collision sphere and a side edge of the virtual finger, and |P_{ig}−Pᵢₕ| is a length of a line segment between a point Pᵢ on the graphic hand and a corresponding position point P′ᵢ on the haptic hand.

In some embodiments, in determining contact between the graphic hand and the virtual object:
the cone frustum-sphere collision detection module further includes following features that:
the graphic hand configuration is a graphic hand configuration at a previous moment
a cross-sectional radius of a cone frustum of each finger knuckle of the graphic hand is increased by Δr;
a radius of a hemisphere of each finger joint of the graphic hand is increased by Δr;
a graphic hand obtained by above changes is used to determine the contact between the graphic hand and the virtual object, and a collision sphere obtained according to the cone frustum-sphere contact determination condition and a sphere-sphere contact determination condition is used to construct the non-penetration contact constraint set.

In some embodiments, the contact processing system further includes: an endpoint contact processing module, configured to:
while constructing the non-penetration contact constraint

$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N$$

for a distal finger knuckle of each finger,
if the collision sphere is in contact with the hemisphere simulating the fingertip, construct a non-penetration contact constraint between the sphere and the hemisphere: |OC|ᵢ²−(Rᵢ+r₂)²≥0, and add the contact constraint to the non-penetration contact constraint set for optimizing finger joint angles of the graphic hand;
if the collision sphere is not in contact with the hemisphere simulating the fingertip, only construct a cone frustum-sphere contact constraint.

In some embodiments, after calculating the normal force Fᵢ of the i-th collision sphere in contact with corresponding virtual finger according to the formula Fᵢ=Gᵢ·n·|P_{ig}−Pᵢₕ|,
the system further calculates a friction force in a sliding process of the virtual hand by using a formula fᵢ=u·nᵢ·|Fᵢ|, where fᵢ represents a friction force at the i-th collision sphere, u represents a dynamic friction coefficient, and nᵢ is a normal vector of a relative motion between the i-th collision sphere and the virtual finger.

In some embodiments, when palm interaction is involved, palm configuration of the graphic hand is optimized, finger configuration of the graphic hand is obtained by matrix transformation, and according to the finger configuration of the graphic hand and the virtual object configuration, the joint angle information of the finger of the graphic hand that is not penetrated into the virtual object is optimized and solved by using the cone frustum-sphere collision detection module, the cone frustum-sphere collision response module and the endpoint contact processing module.

In some embodiments, when multi-finger interaction is processed, a parallel processing mode is used.

According to the specific embodiment provided by the present disclosure, the present disclosure discloses the following technical effects.

The present disclosure provides a contact processing method and system for virtual hand force interaction, aiming at realizing accurate and efficient contact processing. With regard to the structure of a virtual hand, considering different thicknesses of joints of human fingers, fingers are represented by cone frustums. On this basis, a virtual object is constructed by using a sphere-tree model, and a cone frustum-sphere contact processing system for force interaction between the virtual hand and the virtual object is provided. The system can achieve a high (up to 1 kHz) contact processing efficiency while implementing stable, non-penetrating, and realistic force interaction simulation of the virtual hand. An articulated cone frustum is used to simulate a real hand, so that the visualization of the virtual hand is ensured. A small amount of contact constraint between spheres and cone frustums is used to ensure that a side edge of a virtual finger is not penetrated into the virtual object while reducing the computational complexity, and the computational efficiency can be improved by a parallel processing mode, thereby effectively solving the problem in the art of inconsistent visual and haptic feedback due to the fact that a graphic hand and a haptic hand are difficult to match during interaction, resulting from a great appearance difference between a simplified virtual hand model and a real hand, and solving the problem of low contact processing efficiency.

### BRIEF DESCRIPTION OF DRAWINGS

In order to explain the embodiments of the present disclosure or the technical schemes in the prior art more clearly, the drawings required in the embodiments will be briefly introduced hereinafter. Obviously, the drawings in the following description are only some embodiments of the present disclosure. For those skilled in the art, other drawings can be obtained according to these drawings without creative labor.

FIG. 1 is a flowchart of a contact processing method for virtual hand force interaction according to Embodiment 1 of the present disclosure.

FIG. 2 is a schematic diagram showing a contact processing system for virtual hand force interaction according to Embodiment 2 of the present disclosure.

FIGS. 3A to 3C are hybrid virtual hand models based on an articulated cone frustum and different levels of sphere trees according to Embodiment 2 of the present disclosure.

FIGS. 4A to 4C are schematic diagrams showing the cone frustum-sphere contact state for detecting the cone frustum-sphere discrete collision according to Embodiment 2 of the present disclosure.

FIGS. 5A to 5B show that the contact constraint between a sphere-tree model and a cone frustum model has a problem of abnormal endpoint optimization according to Embodiment 2 of the present disclosure.

FIG. 6 is a schematic diagram showing the object sphere-fingertip hemisphere (including a cone frustum of a finger knuckle) contact state for solving an endpoint optimization problem according to Embodiment 2 of the present disclosure.

FIG. 7 is a schematic diagram showing the finger-object interaction contact processing process predicted based on contact constraint according to Embodiment 2 of the present disclosure.

FIG. 8 is a schematic diagram showing a contact force model (partial contact) between a virtual finger and a virtual object according to Embodiment 2 of the present disclosure.

FIG. 9 is a flowchart of a virtual hand force interaction system according to Embodiment 2 of the present disclosure.

### DETAILED DESCRIPTION OF THE INVENTION

The technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without creative labor fall within the scope of protection of the present disclosure.

An objective of embodiments of the present disclosure is to provide a contact processing method and system for virtual hand force interaction. An articulated cone frustum is used to simulate a real hand, so that fidelity of visualization of the virtual hand is ensured, and a contact constraint between spheres and cone frustums is used to ensure that a side edge of a virtual finger is not penetrated into the virtual object, thereby effectively solving the problem in the art of inconsistent visual and haptic feedback due to the fact that a graphic hand and a haptic hand are difficult to match during interaction, resulting from a great appearance difference between a simplified virtual hand model and a real hand.

The objective of embodiments of the present disclosure is to overcome that defects of the prior art, and provide a contact processing method and system for virtual hand force interaction, aiming at realizing efficient and non-penetrating contact processing. With regard to the structure of a virtual hand, considering different thicknesses of joints of human fingers, fingers are represented by cone frustums. On this basis, a virtual object is constructed by using a sphere-tree model, and a cone frustum-sphere contact processing system for force interaction between the virtual hand and the virtual object is provided. The system can achieve a high (up to 1 kHz) contact processing efficiency while implementing stable, non-penetrating, and realistic force interaction simulation of the virtual hand.

In the haptic simulation of the virtual hand, the avatar of the user hand in the virtual environment is called a haptic hand, and its configuration is the direct mapping of the configuration of the real hand of the user in the virtual world (OpenGL or existing engines, such as Unity, Unreal, C++, c#, etc.). In graphic display, the visual avatar of the haptic hand is defined as a graphic hand.

The technical scheme of the present disclosure is as follows. A contact processing system for virtual hand force interaction is provided, which includes a virtual hand construction module, a cone frustum-sphere collision detection module, a cone frustum-sphere collision response module, an endpoint contact processing module and a contact force calculation module. In an embodiment, the contact processing system is consists of a virtual hand construction module, a cone frustum-sphere collision detection module, a cone frustum-sphere collision response module, an endpoint contact processing module and a contact force calculation module.

The virtual hand construction module establishes an articulated cone frustum virtual hand model according to the specific parameters of the finger (including the length of each finger knuckle of each finger and the cross-sectional diameter of both ends of each finger knuckle).

The cone frustum-sphere collision detection module is configured to determine whether a virtual finger collides with a virtual object and return collision information.

The cone frustum-sphere collision response module is configured to calculate the reasonable configuration of the graphic hand quickly and accurately to ensure that the graphic hand is not penetrated into the virtual object.

The endpoint contact processing module is configured to deal with the problem that the fingertip may be suspended or penetrated when the virtual fingertip is in contact with the virtual object.

The contact force calculation module calculates the contact force between the virtual hand and the virtual object according to the collision information obtained by the collision detection module and the optimization result of the collision response module. The above modules will be introduced in detail below from the construction of the virtual hand model.

It is worth explaining the following three questions.

(1) The virtual hand force interaction contact processing system provided by the present disclosure is suitable for different virtual hand interaction applications, such as grasping objects with one hand, manipulating objects with two hands, manipulating objects by multiple-people cooperation, etc. The method provided by the present disclosure supports multi-object operation, multi-hand operation and multi-people cooperation.

(2) The present disclosure focuses on the modeling and contact processing of the finger of the virtual hand. The palm of the virtual hand can be modeled in various ways, such as a sphere-tree model and a triangular mesh model. In this embodiment, the palm of the virtual hand is constructed by using the sphere-tree model.

(3) The contact force calculation module provided by the present disclosure can calculate a normal force at all contact points during the interaction between the virtual object and the virtual hand. On this basis, different feedback force calculation models can be designed according to the force feedback forms (such as fingertip force feedback) provided by different force feedback devices, so that users can experience different feedback force modes through different force feedback devices.

In order to make the above objective, features and advantages of the present disclosure more obvious and understandable, the present disclosure will be further described in detail hereinafter in conjunction with the attached drawings and specific embodiments.

### Embodiment 1

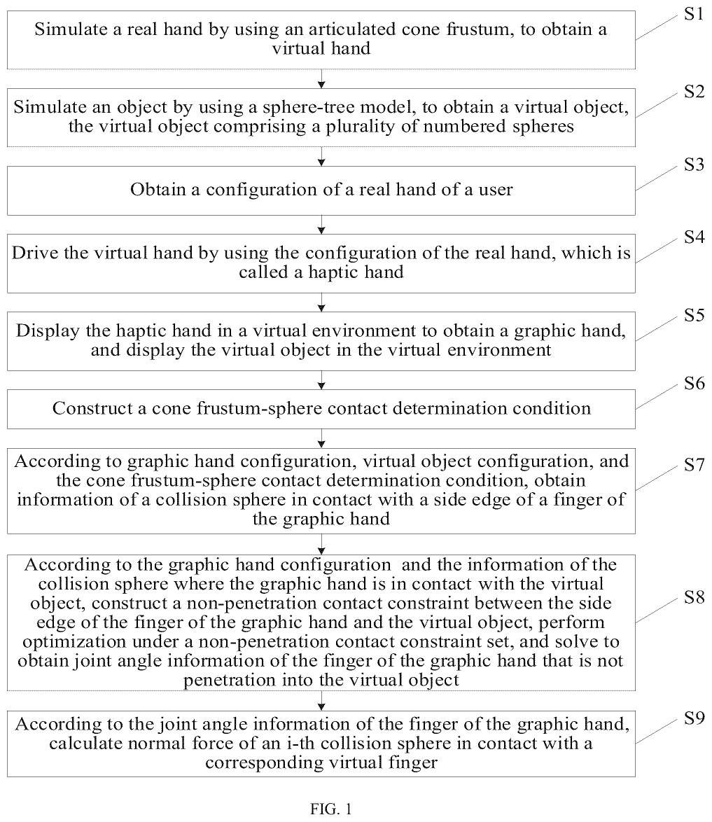

As shown in FIG. 1, this embodiment provides a contact processing method for virtual hand force interaction, where the method includes the following steps S1-S9.

In step S1, a real hand is simulated by using an articulated cone frustum to obtain a virtual hand, where the articulated cone frustum includes a plurality of cone frustums, each of the cone frustums simulates a finger knuckle of the real hand; the virtual hand further includes a plurality of hemispheres, each of the hemispheres is located on a cone frustum simulating a distal finger knuckle, and used to simulate a fingertip of the real hand.

In step S2, an object is simulated by using a sphere-tree model to obtain a virtual object, where the virtual object includes a plurality of numbered spheres.

In step S3, a configuration of the real hand of a user is obtained.

In step S4, the virtual hand is driven by using the configuration of the real hand, and is called a haptic hand.

In step S5, the haptic hand is displayed in a virtual environment to obtain a graphic hand, and the virtual object is displayed in the virtual environment.

In the free space (where the virtual hand is not in contact with the virtual object), the haptic hand is displayed in the virtual environment to obtain a graphic hand, and the virtual object is displayed in the virtual environment. In the constraint space, if the configuration of the haptic hand is directly used for the graphic hand, the graphic hand will be penetrated into the virtual object, and the graphic hand kept on the surface of the virtual object will be obtained through the following contact processing step.

In step S6, a cone frustum-sphere contact determination condition is constructed:

$${\vert OC \vert}_{j}^{2} - {( \frac{{R}_{j}}{cos α} + {k}_{j} * ( {r}_{1} - {r}_{2} ) + {r}_{2} )}^{2} \geq 0 , j = 1 , 2 , … , M and \\ \\ \\ - \frac{{R}_{j}}{\vert DE \vert} \leq k \leq 1 + \frac{{R}_{j}}{\vert DE \vert} ,$$

where |OC|ⱼ is a distance from a center of a sphere numbered j in the virtual object to a central axis l of the cone frustum in the graphic hand, Rⱼ is a radius of the sphere numbered j in the virtual object, M is the number of spheres to be detected in the virtual object,

$${k}_{j} = \frac{\vec{{C}_{j} E}}{\vec{DE}} ,$$

Cⱼ represents a foot point of a perpendicular from the center of the sphere numbered j in the virtual object to the central axis l, E and D represent centers of upper and lower surfaces of the cone frustum in the graphic hand, respectively, α represents an included angle between the side edge of the cone frustum in the graphic hand and the central axis thereof, r₂ and r₁ represent radii of the upper and lower surfaces of the cone frustum in the graphic hand, respectively.

In step S7, according to graphic hand configuration, virtual object configuration, and the cone frustum-sphere contact determination condition, information of a collision sphere in contact with a side edge of a finger of the graphic hand is obtained. Where, the information of the collision sphere includes a collision sphere number, a sphere center coordinate of the collision sphere and a sphere radius of the collision sphere; the collision sphere is a sphere in the virtual object in contact with the graphic hand; the side edge of the finger of the graphic hand is the side edge of a cone frustum simulating a finger knuckle of the finger; the graphic hand configuration is used for graphic display.

In step S8, with θ_{1g}^{t}, θ_{2g}^{t} and θ_{3g}^{t} representing a metacarpophalangeal joint angle, a proximal interphalangeal joint angle and a distal interphalangeal joint angle of each finger of the graphic hand, respectively, according to the graphic hand configuration and the information of the collision sphere where the graphic hand is in contact with the virtual object, a non-penetration contact constraint between the side edge (i.e. the cone frustum) of the finger of the graphic hand and the virtual object (i.e. the sphere) is constructed as:

$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N ,$$

where N is the number of spheres in the virtual object which are in contact with the virtual fingers of the graphic hand; according to the non-penetration contact constraint between the cone frustum and the sphere, optimization is performed on three joint angles θ_{1g}^{t}, θ_{2g}^{t} and θ_{3g}^{t} of each finger of the graphic hand as a whole under a non-penetration contact constraint set, to obtain joint angle information of the finger of the graphic hand that is not penetrated into the virtual object.

In step S9, according to the joint angle information of the finger of the graphic hand and formula Fᵢ=Gᵢ·n·|P_{ig}−Pᵢₕ|, normal force Fᵢ of an i-th collision sphere in contact with a corresponding virtual finger is calculated, where Gᵢ is a 3×3 stiffness matrix, n represents a unit vector of \vec{OᵢPᵢ}, Oᵢ represents a center of the i-th collision sphere, Pᵢ represents a contact point between the i-th collision sphere and the side edge of the virtual finger, and |P_{ig}−Pᵢₕ| is a length of a line segment between a point Pᵢ on the graphic hand and a corresponding position point P′ᵢ on the haptic hand.

The graphic hand and its configuration used in the cone frustum-sphere contact determination condition and the sphere-sphere contact determination condition further include the following features that:
the graphic hand configuration is the graphic hand configuration at a previous moment;
a cross-sectional radius of the cone frustum of each finger knuckle of the graphic hand is increased by Δr;
a radius of the hemisphere of each finger knuckle of the graphic hand is increased by Δr;
the graphic hand obtained by the above changes is used to determine the contact between the graphic hand and the virtual object, and the collision sphere obtained according to the cone frustum-sphere contact determination condition and the sphere-sphere contact determination condition is used to construct the non-penetration contact constraint set.

While constructing the non-penetration contact constraint

$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N$$

for the distal finger knuckle of each finger, the method further includes:
if the collision sphere is in contact with the hemisphere simulating the fingertip, constructing a non-penetration contact constraint between the sphere and the hemisphere. |OC|ᵢ²−(Rᵢ+r₂)²≥0, and adding the contact constraint to the non-penetration contact constraint set for optimizing finger joint angles of the graphic hand.

After calculating a normal force Fᵢ of an i-th collision sphere in contact with a corresponding virtual finger according to the formula Fᵢ=Gᵢ·n·|P_{ig}−Pᵢₕ|, the method further includes:
calculating a friction force in a sliding process of the virtual hand by using a friction calculation formula, such as the virtual finger sliding on the surface of the virtual object, using formula fᵢ=u·nᵢ·|Fᵢ|, where fᵢ represents the friction force at the i-th collision sphere, u represents a dynamic friction coefficient, and nᵢ is a normal vector of a relative motion direction of the virtual finger relative to the i-th collision sphere.

The preferred embodiment of the application is given above. The application can be implemented in many different forms, such as the construction of the virtual hand model, the configuration optimization method of the virtual hand and the calculation method of an interaction force, etc., which is not limited to the embodiment described herein.

### Embodiment 2

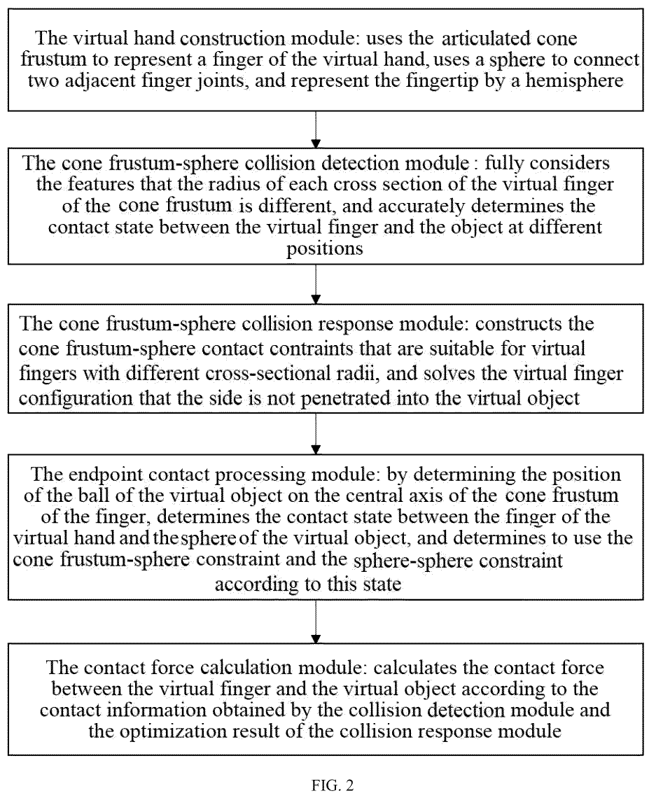

As shown in FIG. 2, this embodiment provides a contact processing system for virtual hand force interaction, where the system includes a virtual hand construction module, a cone frustum-sphere collision detection module, a cone frustum-sphere collision response module, an endpoint contact processing module and a contact force calculation module.

The virtual hand construction module is configured to perform the following operations:
a real hand is simulated by using an articulated cone frustum to obtain a virtual hand, where the virtual hand includes a plurality of cone frustums, each of the cone frustums simulates a finger knuckle of the real hand; a metacarpophalangeal joint and two interphalangeal joints each are simulated by a sphere; the virtual hand further includes a plurality of hemispheres, each of the hemispheres is located on a cone frustum simulating a distal finger knuckle, and used to simulate a fingertip of the real hand;
an object is simulated by using a sphere-tree model to obtain a virtual object, where the virtual object includes a plurality of numbered spheres;
a configuration of the real band of a user is obtained;
the virtual hand is driven by using the configuration of the real hand, which is called a haptic hand;
in the free space, the haptic hand is displayed in the virtual environment to obtain a graphic hand, and the virtual object is displayed in the virtual environment; in the constraint space, if the configuration of the haptic hand is directly used for the graphic hand, the graphic hand will be penetrated into the virtual object, and the graphic hand kept on the surface of the virtual object will be obtained through the contact processing of the following functional modules.

In this embodiment, the virtual hand construction module uses the articulated cone frustum to construct the virtual finger, that is, uses the cone frustum (with different diameters of upper and lower sections) to represent each segment of the virtual finger, uses a sphere to connect two adjacent finger knuckles to represent the joint, and represents the fingertip by a hemisphere. In order to better simulate the thumb, other models (such as a sphere-tree model) can be used to construct the metacarpophalangeal joint of the thumb.

It is worth noting that the present disclosure mainly describes the finger constructing model of the virtual hand. The palm of the virtual hand can be constructed by using a triangular mesh model, a sphere-tree model and the like, which are all within the scope of protection of the present disclosure.

Specifically, the construction of virtual tools and virtual objects by using a sphere-tree model is very effective in improving the calculation efficiency and non-penetrating simulation of a tool-based six-degree-of-freedom force synthesis method. However, an octree sphere is used to construct the virtual hand. In the process of realizing the interaction between the virtual hand and the virtual object, with the increase in the number of interaction/contact fingers and contacts, the contact processing is also more time-consuming. The finger knuckle of the real human hand can be approximated as a cone frustum. The finger of the virtual hand can be represented by the articulated cone frustum, and a cone frustum represents a finger knuckle of the finger. Intuitively, the number of cone frustums used for modeling the virtual hand is less than the number of spheres required by the sphere-tree model. Compared with the multi-layer sphere-tree model, using an articulated cone frustum to represent fingers is more conducive to efficiently performing the contact processing of the virtual hand force interaction.

For each virtual finger knuckle constructed with a cone frustum, there are three key parameters, that is, the length of the finger knuckle and the diameters of upper and lower end faces of the finger knuckle. The above three parameters can be obtained by measuring the length of the finger knuckle of the real hand of the user and the diameter of the cross section at each joint. In addition, in order to realize visual display and interaction reality, a sphere is used to represent the joint between adjacent finger knuckles, and a hemisphere is connected to the cone frustum of the distal finger knuckle to represent the fingertip.

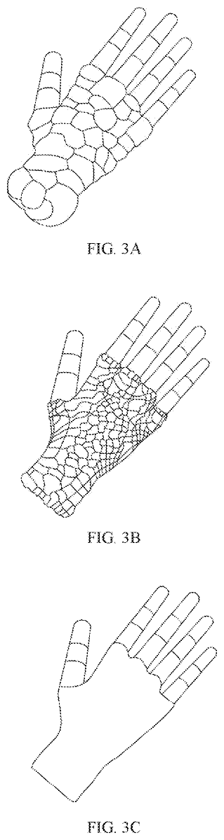

The human palm is a complex object composed of five metacarpals. The metacarpal of the thumb has rotational degree of freedom, and the activities of the other four metacarpals are very small. The metacarpal area of the thumb is regarded as the phalanx, and is represented by the cone frustum model like other phalanxes. Therefore, each finger of the virtual hand is modeled by an articulated cone frustum including three cone frustums. Considering the small range of motion of the other four metacarpals, the palm except the thumb metacarpal area can be regarded as a rigid body, and the rigid body can be further represented by an octree sphere model. FIGS. 3A to 3C show virtual hand models based on an articulated cone frustum, in which the palm uses an octree sphere model of different levels.

The cone frustum-sphere collision detection module is configured to perform the following operations:
a cone frustum-sphere contact determination condition:

$${\vert OC \vert}_{j}^{2} - {( \frac{{R}_{j}}{cos α} + {k}_{j} * ( {r}_{1} - {r}_{2} ) + {r}_{2} )}^{2} \leq 0 , j = 1 , 2 , … , M and \\ - \frac{{R}_{j}}{\vert DE \vert} \leq k \leq 1 + \frac{{R}_{j}}{\vert DE \vert} ,$$

where |OC|ⱼ is a distance from a center of the sphere numbered j in the virtual object to a central axis l of the cone frustum in the graphic hand, Rⱼ is a radius of the sphere numbered j in the virtual object, M is the number of spheres to be detected in the virtual object,

$${k}_{j} = \frac{\vec{{C}_{j} E}}{\vec{DE}} ,$$

Cⱼ represents a foot point of a perpendicular from the center of the sphere numbered j in the virtual object to the central axis l, E and D represent centers of upper and lower surfaces of the cone frustum in the graphic hand, respectively, α represents an included angle between the side edge of the cone frustum in the graphic hand and the central axis thereof, r₂ and r₁ represent radii of the upper and lower surfaces of the cone frustum in the graphic hand, respectively;
according to the contact constraint between the spheres and the cone frustums, the finger configuration of the graphic hand and information of the collision sphere are obtained, where the information of the collision sphere includes a collision sphere number, a sphere center coordinate and a sphere radius; the collision sphere is a sphere in contact with the finger of the graphic hand.

According to graphic band configuration, virtual object configuration, and cone frustum-sphere contact determination condition, information of the collision sphere in contact with a side of a finger of the graphic hand is obtained, where the information of the collision sphere includes a collision sphere number, a sphere center coordinate of the collision sphere and a sphere radius of the collision sphere; the collision sphere is a sphere in the virtual object in contact with the graphic hand; the side edge of the finger of the graphic hand is the side edge of the cone frustum simulating a finger knuckle of the finger; the graphic hand configuration is used for graphic display.

In this embodiment, the cone frustum-sphere collision detection module uses the cone frustum-sphere collision detection algorithm to determine whether the virtual finger collides with the virtual object on the basis that the virtual finger is represented by the cone frustum and the virtual object is represented by the sphere-tree model. The algorithm fully considers the features that the radius of each cross section of the virtual finger of the cone frustum is different, and can accurately determine the contact state between the virtual finger and the object at different positions.

Specifically, the purconfiguration of collision detection is to determine whether the avatar of the virtual hand is in contact with the virtual object in the virtual environment at a certain moment and what the contact mode is. In order to support real-time contact processing, the collision detection algorithm for virtual band interaction needs to have high computational efficiency. At the same time, it is necessary to accurately calculate the relevant parameters of the contact state between the virtual hand and the virtual object, so as to provide accurate contact information for the collision response. The cone frustum-sphere collision detection algorithm proconfigurationd in this embodiment determines the contact state between the virtual finger and the virtual object.

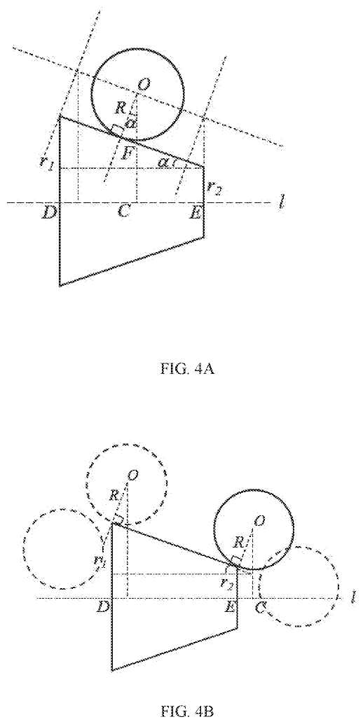

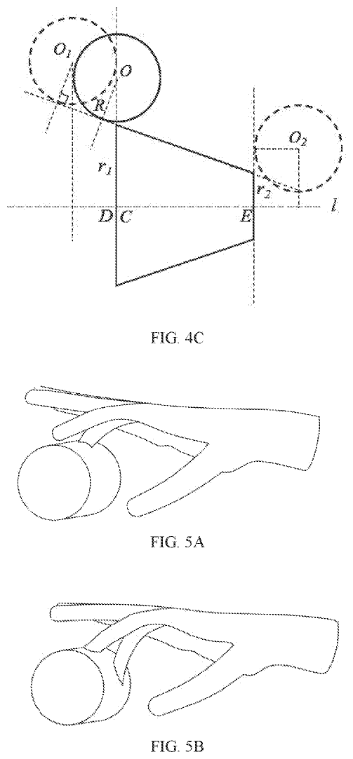

As shown in FIGS. 4A to 4C, the circle is a sphere in the virtual object, and the trapezoid represents the cone frustum simulating a finger. The point C is the foot point from the center O of the sphere to the central axis l of the cone frustum. D and E represent the centers of the two circular bottoms of the cone frustum, whose coordinates are (x_{D}, y_{D}, z_{D}) and (x_{E}, y_{E}, z_{E}), respectively. The contact state between the virtual object and the finger can be determined by comparing the current |OC| (that is, the distance from the center O of the object sphere to the central axis l of the virtual finger) and the threshold |OC|^{Γ} when the sphere is tangent to the side of the cone frustum (FIG. 4A). If |OC|≤|OC|^{Γ} is satisfied, it can be determined that the cone frustum collides with the sphere. |OC| can be calculated by the following formula:

$${\vert OC \vert}^{2} = \frac{{l}_{2}^{2} + {l}_{3}^{2} + {l}_{4}^{2}}{{l}_{1}^{2}} , \qquad ( 1 )$$

where l₁, l₂, l₃ and l₄ are calculated by the following formula:

$$\{ \begin{matrix}{l}_{1} = \sqrt{{( {x}_{E} - {x}_{D} )}^{2} + {( {y}_{E} - {y}_{D} )}^{2} + {( {z}_{E} - {z}_{D} )}^{2}} \\ {l}_{2} = ( {y}_{D} - {y}_{O} ) ( {z}_{E} - {z}_{D} ) - ( {y}_{E} - {y}_{D} ) ( {z}_{D} - {z}_{O} ) \\ {l}_{3} ( {z}_{D} - {z}_{O} ) ( {x}_{E} - {X}_{D} ) - ( {z}_{E} {z}_{D} ) ( {x}_{D} {x}_{O} ) \\ {l}_{4} = ( {x}_{D} - {x}_{O} ) ( {y}_{E} - {y}_{D} ) - ( {x}_{E} - {x}_{D} ) ( {y}_{D} - {y}_{O} )\end{matrix} . \qquad ( 2 )$$

Assuming that the radii of the upper and lower bottom parts of the cone frustum are r₂ and r₁ (r₂<r₁), respectively, the threshold |OC|^{Γ} of the collision detection conditions can be calculated by the following formula:

$${\vert OC \vert}^{Γ} = \frac{R}{cos α} + k * ( {r}_{1} - {r}_{2} ) + {r}_{2} , \qquad ( 3 )$$

where R is the radius of the spherical surface, α is an included angle between the side edge of the cone frustum and the central axis thereof, k represents the position of the center axis of the center O of the virtual sphere (i.e. the ratio of \vec{CE} to \vec{DE}) where the foot point C is located on the central axis l of the virtual finger. The calculation formula is as follows:

$$k = \frac{\vec{OE} \cdot \vec{CE}}{\vert \vec{CE} \vert \cdot \vert \vec{DE} \vert} = \frac{\vec{OE} \cdot \vec{DE}}{{\vert \vec{DE} \vert}^{2}} = \frac{{l}_{5}}{{l}_{1}^{2}} , \qquad ( 4 )$$

where l₅=(x_{O}−x_{E}) (x_{D}−x_{E})+(y_{O}−y_{E}) (y_{D}−y_{E})+(z_{O}−z_{E}) (z_{D}−z_{E}).

As shown in FIG. 4B, although the condition |OC|≤|OC|^{Γ} is satisfied, the gray dashed sphere is not in contact with the cone frustum. More specifically, when k>1+R/|DE| or k<−R/|DE|, the sphere will be not in contact the cone frustum. When k=1+R/|DE|, the spherical surface is tangent to the lower bottom (extension) of the cone frustum (that is, the black dashed sphere O₁ in FIG. 4C). When k=−R/|DE|, the sphere is tangent to the upper bottom (extension) of the cone frustum (that is, the black dashed sphere O₂ in FIG. 4C). When k=0, the foot point C coincides with the endpoint E. When k=1, the foot point C coincides with the endpoint D. Generally speaking, there is another condition to determine the collision between the sphere and the cone frustum, that is, −R/|DE|<k<1+R/|DE|. Therefore, it can be determined that the virtual finger collides with the virtual object when the following conditions are satisfied:

$${\vert OC \vert}^{2} \leq {( \frac{R}{cos α} + k * ( {r}_{1} - {r}_{2} ) + {r}_{2} )}^{2} \\ - \frac{R}{\vert DE \vert} \leq k \leq 1 + \frac{R}{\vert DE \vert} . \qquad ( 5 )$$

The cone frustum-sphere collision response module is configured to perform the following operations:
with θ_{1g}^{t}, θ_{2g}^{t} and θ_{3g}^{t} representing a metacarpophalangeal joint angle, a proximal interphalangeal joint angle and a distal interphalangeal joint angle of each finger of the graphic hand, respectively, according to the graphic hand configuration and the information of the collision sphere where the graphic hand is in contact with the virtual object, a non-penetration contact constraint

$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N$$

between the side edge (i.e. the cone frustum) of the finger of the graphic hand and the virtual object (i.e. the sphere) is constructed, where N is the number of spheres in the virtual object which are in contact with the virtual fingers of the graphic hand; according to the non-penetration contact constraint between the cone frustums and the spheres, optimization is performed on three joint angles θ_{1g}^{t}, θ_{2g}^{t} and θ_{3g}^{t} of each finger of the graphic hand as a whole under a non-penetration contact constraint set, and the three joint angles are solve to obtain joint angle information of the finger of the graphic hand that is not penetrated into the virtual object.

In this embodiment, based on the collision information obtained by the cone frustum-sphere collision detection algorithm, the cone frustum-sphere collision response module uses the cone frustum-sphere collision response algorithm to solve the reasonable virtual hand configuration. This algorithm constructs the cone frustum-sphere contact constraints that are suitable for virtual fingers with different cross-sectional radii, and can optimize and solve the virtual finger configuration where the side is not penetrated into the virtual object.

Specifically, the collision response is one of the core components for force rendering. The module needs the information obtained by the collision detection module as its input, and then performs the collision response related calculation. In the early period, the contact processing of the virtual hand force interaction relies on the pre-defined prior information of the contact between the hand and/or the object, and the collision response is performed according to the proximity between the actual operation behavior and the pre-defined operation behavior. This method performs well in the pre-defined operation, but in practical application, there will be unrealistic contact (such as mutual penetration) between the virtual hand and the manipulated object. In order to realize realistic virtual hand interaction, this embodiment uses a constraint-based method to perform the contact processing in the process of the virtual hand force interaction. Specifically, the optimization target is established for the constructed virtual hand model, and the non-penetrating constraint of the interaction between the virtual hand and the virtual object is established according to the collision detection result, and finally the reasonable graphic configuration of the virtual hand that does not penetrate into the virtual object is obtained.

In the haptic interaction simulation of the virtual hand, the direct mapping avatar of the hand of the user in the virtual environment is called a haptic hand, the configuration of which is obtained by directly mapping the configuration of the real hand (for example, HTC Tracker obtains the position information of six degrees of freedom of the hand, a Noitom Data Glove obtains the bending angle of each finger knuckle) into the virtual world. The visual avatar of the haptic hand is defined as a graphic hand, which is used for graphic display. In order to reproduce the virtual hand interaction realistically and naturally, it is necessary to ensure that the graphic hand will not penetrate into the virtual object during the interaction.

In this embodiment, the finger of the virtual hand uses an articulated cone frustum, and it is necessary to construct a cone frustum-sphere contact constraint to calculate the finger configuration (for display) of the graphic hand during interaction with the virtual object, where θ_{g}^{t}=(θ_{1g}^{t}, θ_{2g}^{t}, θ_{3g}^{t}). θ_{1g}^{t}, θ_{2g}^{t} and θ_{3g}^{t} represent a metacarpophalangeal joint angle, a proximal interphalangeal joint angle and a distal interphalangeal joint angle of each finger, respectively. The three joint angles of each finger are optimized as a whole, and the optimization target can be written as:

$$Min : \frac{1}{2} {( {θ}_{g}^{t} - {θ}_{h}^{t} )}^{T} {G}_{r} ( {θ}_{g}^{t} - {θ}_{h}^{t} ) \qquad ( 6 )$$

where θₕ^{t}=(θ₁ₕ^{t}, θ₂ₕ^{t}, θ₃ₕ^{t}) represents the finger joint angle information of the haptic band (i.e. acquired by hardware devices (such as data gloves)). The definition of θ₁ₕ^{t}, θ₂ₕ^{t} and θ₃ₕ^{t} is the same as that of θ_{1g}^{t}, θ_{2g}^{t} and θ_{3g}^{t}. Gᵣ is a 3×3 diagonal torsional stiffness matrix.

After knowing the palm configuration q_{g}^{t} (3DoF (degree of freedom) translation and 3oF rotation) and the joint angle information (θ_{1g}^{t}, θ_{2g}^{t} and θ_{3g}^{t}) of fingers of the graphic hand, the coordinates (x_{D}, y_{D}, z_{D}) and (x_{E}, y_{E}, z_{E}) of centers D and E of the two bottom surfaces of the cone frustum in the global coordinate system is obtained through the following matrix transformation:

$${P}_{D / E} = {M}_{0} ( {q}_{g}^{t} ) {M}_{s} ( {θ}_{s} ) {M}_{1} ( {θ}_{1 g}^{t} ) {M}_{2} ( {θ}_{2 g}^{t} ) {M}_{3} ( {θ}_{3 g}^{t} ) {P}_{{D}_{0} / {E}_{0}} \qquad ( 7 )$$

where P_{D/E} indicates the coordinate of D or E in the global coordinate system, P_{D}_{₀}_{/E}_{₀} indicates the local coordinate of D or E, which is determined by the length of the finger knuckle of the virtual finger. M₀(q_{g}^{t}) is a homogeneous translational rotation matrix containing six-dimensional variables in q_{g}^{t}. Mₛ(θₛ) is the rotation matrix of abduction motion of metacarpophalangeal joint, and θₛ is an abduction angle. M₁(θ_{1g}^{t}) is a homogeneous translational rotation matrix of the metacarpal joint with respect to the carpometacarpal joint coordinate system, M₂(θ_{2g}^{t}) is a translational rotation matrix of the proximal interphalangeal joint with respect to the metacarpal joint, and M₃(θ_{3g}^{t}) is a translational rotation matrix of the distal interphalangeal joint with respect to the proximal interphalangeal joint.

Therefore, the contact constraint between the cone frustum and the spherical surface can be expressed as:

$${C}_{j} ( {x}_{D} ( {θ}_{g}^{t} ) , {y}_{D} ( {θ}_{g}^{t} ) , {z}_{D} ( {θ}_{g}^{t} ) , {x}_{E} ( {θ}_{g}^{t} ) , {y}_{E} ( {θ}_{g}^{t} ) , {z}_{E} ( {θ}_{g}^{t} ) ) \geq 0 , \\ j = 1 , 2 , … , M \qquad ( 8 )$$

where Cⱼ represents the j-th constraint condition, M is the number of spheres in contact with the cone frustum in the virtual object.

According to the cone frustum-sphere collision detection condition (Formula (5)) described in the cone frustum-sphere collision detection module, the contact constraint between the sphere and the cone frustum in Formula (8) can be expressed as:

$${\vert OC \vert}_{j}^{2} - {( \frac{{R}_{j}}{cos α} + {k}_{j} * ( {r}_{1} - {r}_{2} ) + {r}_{2} )}^{2} \underline{>} 0 , j = 1 , 2 , … , M \qquad ( 9 )$$

where |OC|ⱼ is a distance from a center O(x_{Oj}, y_{Oj}, z_{Oj}) of the j-th sphere that collides with the cone frustum to the central axis l of the cone frustum, Rⱼ is the radius of the sphere, kⱼ represents the position of the foot point of the center O(x_{Oj}, y_{Oj}, z_{Oj}) of the sphere on the central axis l, that is, \vec{CE}/\vec{DE}. Formula (8) is the unified writing of constraints, and formula (9) is the calculation method of constraints.

For a specific finger, the parameters r₁, r₂ and α of the cone frustum are constant. (x_{D}(θ_{g}^{t}), y_{D}(θ_{g}^{t}), z_{D}(θ_{g}^{t})) and (x_{E}(θ_{g}^{t}), y_{E}(θ_{g}^{t}), z_{E}(θ_{g}^{t})) are substituted into Formula (2) and Formula (4). Formula (9) can be expressed by the parameters to be optimized. After the contact constraint is linearized by Taylor expansion, the joint angle information (θ_{1g}^{t}, θ_{2g}^{t} and θ_{3g}^{t}) of five fingers of the graphic hand is obtained by performing iterative optimization and solving using an effective set method.

The endpoint contact processing module is configured to perform the following operation:
the problem that the fingertip of the virtual hand may be suspended or penetrated when it comes into contact with the virtual object is solved. By determining the position of the sphere of the virtual object on the central axis of the cone frustum of the finger, the module determines the contact state between the finger of the virtual hand and the sphere of the virtual object, and determines whether to use the cone frustum-sphere constraint or the sphere-sphere constraint when the collision response constraint is optimized and solved according to this state.

Specifically, in the process that the sphere-cylinder collision response algorithm is used to perform virtual hand interaction, the problem of abnormal optimization of the fingertip configuration of the finger will occur. As shown in FIGS. 5A to 5B, FIG. 5A is a case where the fingertip of the finger of the graphic hand is suspended (that is, the graphic hand is separated from the virtual object), and FIG. 5B is a case where the finger of the graphic hand is penetrated (that is, the graphic hand penetrates into the virtual object).

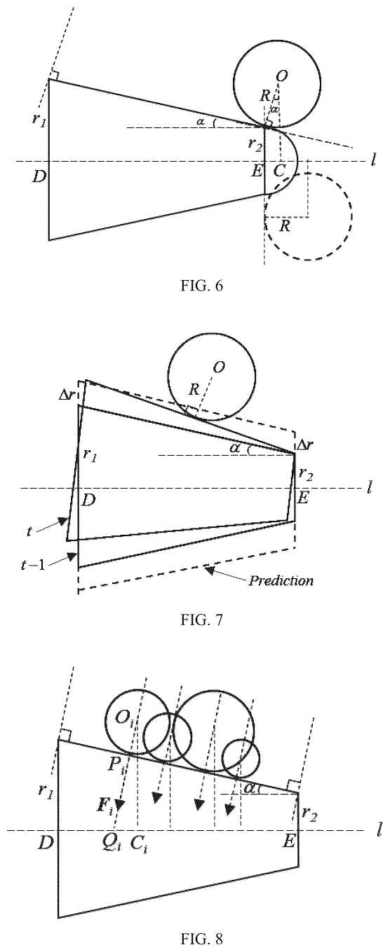

In order to solve the above-mentioned abnormal endpoint problem, this embodiment constructs an endpoint contact processing module. The contact state between the fingertip of the virtual finger and the sphere on the object is shown in FIG. 6. When the hemisphere connected to the bottom of the cone frustum collides with the sphere of the object, the contact state between the fingertip of the virtual finger and the virtual object is determined by sphere-sphere collision detection, that is, by comparing whether the distance between the fingertip and the center of two spheres in the virtual object is less than the sum of the radii of the two spheres, as shown in the following formula:

$${\vert OC \vert}^{2} \leq {( R + {r}_{2} )}^{2} \qquad ( 10 )$$

where |OC|²=(x_{T}−x_{O})²+(y_{T}−y_{O})²+(z_{T}−z_{O})², (x_{T}, y_{T}, z_{T}) and (x_{O}, y_{O}, z_{O}) represent the sphere center coordinates of the virtual fingertip hemisphere and the virtual object sphere in the global coordinate system, respectively, and R represents the radius of the virtual object sphere.

Specifically, according to the cone frustum-sphere collision detection conditions, the state of the collision sphere is saved while the information of the collision sphere itself (including a sphere number, a sphere center coordinate and a sphere radius) is saved. When constructing the constraint, if the state of the collision sphere is that the position of its center on the central axis of the cone frustum satisfies both Formula (11) and Formula (10), the contact constraint of the sphere is established as a sphere-sphere contact constraint, otherwise, the contact constraint of the sphere is established as a cone frustum-sphere contact constraint represented by Formula (8):

$$- \frac{R + {r}_{2}}{\vert DE \vert} \leq k < - \frac{R * sin α}{\vert DE \vert} \qquad ( 11 )$$

where R represents the radius of the sphere colliding with the cone frustum. The sphere-to-sphere contact constraint indicates that the distance between the centers of two spheres is greater than or equal to the sum of the radii of the two spheres, which is obtained according to the sphere-to-sphere collision detection condition in Formula (10). Each pair of spheres is processed in the same way, and it is not necessary to distinguish the sequence of the sphere.

Formula (11) is obtained according to the geometric relationship between the object sphere and the fingertip hemisphere and between the object sphere and the finger cone frustum in FIG. 6.

k=−R*sin α/|DE| indicates that the connecting line between the center of the object sphere and the edge of the upper bottom of the finger cone frustum is perpendicular to the side of the cone frustum.

When

$$k = - \frac{R + {r}_{2}}{\vert DE \vert} ,$$

the object sphere is tangent to the fingertip hemisphere.

In addition, when the haptic hand is deeply penetrated into the virtual object, there will be an abnormal optimization problem of the graphic hand, that is, the phenomenon that the virtual finger is penetrated into the virtual object. This is mainly because the haptic hand is used as the collision subject. When the haptic hand is deeply penetrated into the virtual object (even penetrates into the virtual object), the result of collision detection is the object sphere that is in contact with the haptic hand at the current moment. On the one hand, these spheres may not be on the surface of the virtual object, which makes it impossible to establish surface contact constraints. On the other hand, when the haptic hand penetrates into the virtual object, the result of collision detection is basically invalid, which leads to the failure to establish proper cone frustum-sphere and sphere-sphere contact constraints. Therefore, it is impossible to obtain the appropriate graphic hand configuration by optimization.

Through the analysis of the abnormal optimization problem of the graphic hand when deeply penetrated into the virtual object, this embodiment uses the graphic hand as the subject of collision detection, and detects whether the finger components of the graphic hand, that is, the cone frustum and the sphere, collide with the object sphere. The collision result is used to construct the cone frustum-sphere and sphere-sphere contact constraints. In addition, the idea of contact prediction is used to alleviate the problem of missed detection. As shown in FIG. 7, the black trapezoid represents finger knuckles of the graphic hand at the moment t−1, and the radius of each cross section of the finger knuckles at the moment t−1 is increased by Δr to obtain the dotted trapezoid. Then, the cone frustum-sphere contact pair is obtained by using the collision detection algorithm described in Section 2, and the contact constraint between the cone frustum and the sphere is established according to Formula (8). Finally, after the Taylor expansion is used to linearize the contact constraint under this constraint, the effective set method is used to iteratively optimize and solve the non-penetrating joint angle of the virtual finger. The trapezoid t shown in FIG. 7 is the calculated finger of the virtual hand.

As an optional embodiment, when palm interaction is involved, palm configuration of the graphic hand is optimized first, and the finger configuration of the graphic hand is obtained by matrix transformation, and then according to the finger configuration of the graphic hand and the configuration of the virtual object, the cone frustum-sphere collision detection module, the cone frustum-sphere collision response module and the endpoint contact processing module are used to optimize and solve the joint angle information of the finger of the graphic hand that is not penetrated into the virtual object.

The contact force calculation module is configured to perform the following operation:
the contact force information during the interaction between the virtual hand and the virtual object is calculated. The module calculates the contact force information between the virtual finger and the virtual object during interaction according to the contact information obtained by the collision detection module and the optimization result of the collision response module.

It is worth noting that in addition to the contact force calculation method involved in the contact point and the contact area mentioned in the present disclosure, a more abundant feedback force is calculated according to the contact information obtained by the collision detection module and the optimization result of the collision response module proconfigurationd in the present disclosure, for example, a normal contact force of fingertips can be calculated for force feedback gloves that can only provide a fingertip feedback force, which is also within the scope of protection of the present disclosure.

Specifically, in addition to efficient and accurate collision detection and collision response algorithms, the contact force calculation during the interaction between the virtual finger and the virtual object is another key link to realize continuous and stable force feedback. FIG. 8 shows the partial contact during the interaction between the virtual finger and the virtual object, in which the gray trapezoid represents the cross section of a virtual finger knuckle (cone frustum), and the black circle represents some spheres on the surface of the virtual object that is in contact with the virtual finger. The contact state between the virtual hand and the virtual object shown in FIG. 8 is obtained by a series of contact processing methods such as a collision detection algorithm and a collision response algorithm, and is finally solved by optimization. Specifically, during the interaction between the virtual hand and the virtual object, the virtual finger is not penetrated into the virtual object.

Assuming that there are n spheres on the surface of the virtual object in contact with the virtual finger. Taking FIG. 8 as an example, assuming that the contact point (i.e. tangent point) between the i-th sphere (the center of the sphere is Oᵢ) and the side edge of the virtual finger is Pᵢ, the normal force (gray arrow) on the virtual finger during the interaction is Fᵢ, and its direction is perpendicular to the side edge of the virtual finger, that is, the same as the direction of the vector \vec{OP}ᵢ. The global coordinate (x_{O}_{ᵢ}, y_{O}_{ᵢ}, z_{O}_{ᵢ}) of the sphere center Oᵢ is known, and the global coordinate (x_{P}_{ᵢ}, y_{P}_{ᵢ}, z_{P}_{ᵢ}) of Pᵢ should be solved first for calculating the direction of Fᵢ.

Next, a calculation method of the global coordinate (x_{P}_{ᵢ}, y_{P}_{ᵢ}, z_{P}_{ᵢ}) of Pᵢ is introduced. Assuming that the intersection point between the extension line of \vec{OP}ᵢ and l is Qᵢ(x_{Q}_{ᵢ}, y_{Q}_{ᵢ}, z_{Q}_{ᵢ}), and |\vec{OᵢCᵢ}| can be calculated by formula (3). Furthermore, the global coordinate (x_{Q}_{ᵢ}, y_{Q}_{ᵢ}, z_{Q}_{ᵢ}) of Qᵢ and the ratio of |\vec{OᵢPᵢ}| to |\vec{OᵢQᵢ}| can be calculated on the premise that α and the position characterization parameters kᵢ of Cᵢ on the central axis l (formula (4)) are known, so as to calculate the global coordinate (x_{P}_{ᵢ}, y_{P}_{ᵢ}, z_{P}_{ᵢ}) of Pᵢ, which is denoted as P_{ig}, that is, the coordinate of the contact position on the graphic hand. In the same way, according to the local coordinates of two end points of the corresponding finger knuckles on the haptic hand, the global coordinate at the position P′ᵢ corresponding to Pᵢ can be calculated, which can be denoted as Pᵢₕ. The normal force Fᵢ of an i-th collision sphere in contact with a corresponding virtual finger knuckle can be calculated by the following formula:

$${F}_{i} = {G}_{i} \cdot n \cdot \vert {P}_{ig} - {P}_{ih} \vert \qquad ( 12 )$$

where Gᵢ is a 3×3 stiffness matrix.

$$n = \frac{\vec{{OP}_{i}}}{\vert \vec{{O}_{i} {P}_{i}} \vert}$$

represents a unit vector of \vec{OP}ᵢ. |P_{ig}−Pᵢₕ| is a length of a line segment between a point Pᵢ on the graphic hand and a corresponding position point P′ᵢ on the haptic hand.

Further, if there is a trend of relative motion or relative motion occurs between the i-th sphere and the virtual finger, the friction force fᵢ between the i-th sphere and the virtual finger can be calculated by the contact normal force calculated by the present disclosure. If relative friction occurs therebetween, and the friction coefficient of the virtual object surface is u, a method of calculating fᵢ is:

$${f}_{i} = u \cdot {n}_{i} \cdot \vert {F}_{i} \vert \qquad ( 13 )$$

where nᵢ is a normal vector of the relative motion between the i-th sphere and the virtual finger.

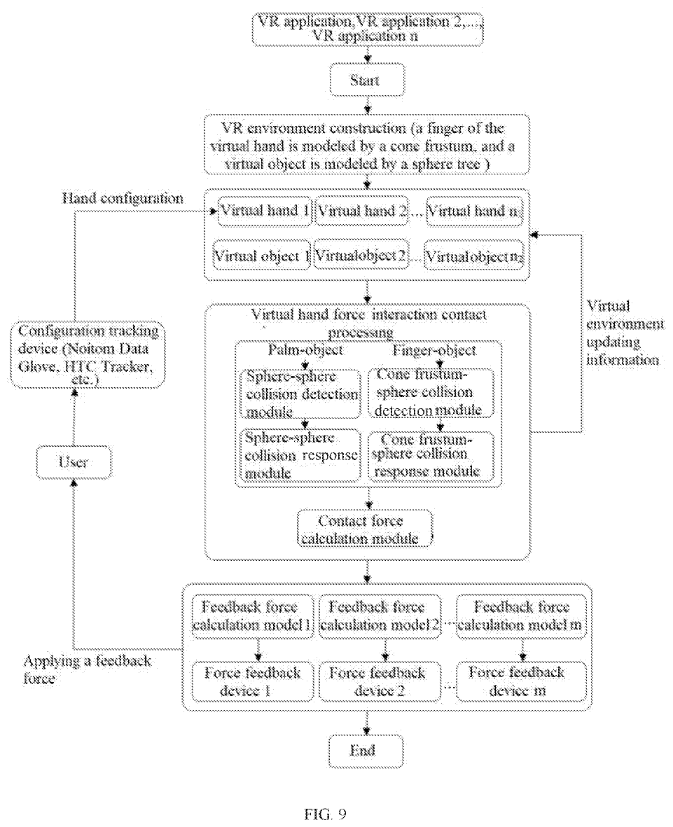

The normal force and the friction force resulted from contact between a sphere on the surface of a virtual object and a virtual finger are calculated above. Considering the form of a feedback force that the used force feedback device can provide and the position of the force applied on the finger, the feedback force that the force feedback device needs to provide can be further calculated. The specific flow chart of this embodiment is shown in FIG. 9.

The contact processing method and system for virtual hand force interaction can be used not only for single-finger knuckle interaction of a single finger, but also for multi-finger knuckle interaction of a single finger, and multi-finger interaction. When multi-finger interaction is involved, a parallel processing mode can be used to improve the efficiency of contact processing, which is within the scope of protection of the present disclosure.

It is worth noting that the interaction here includes operations such as virtual hand touching, grasping virtual objects and sliding on the surface of objects, as well as single-person two-handed operation and multi-people cooperation.

The contact processing method and system for virtual hand force interaction not only support the virtual hand to perform interaction operation with a virtual object in the virtual environment in the above-mentioned interaction mode, but also support the interaction between the virtual hand and various virtual objects with different shapes in the virtual environment, which is also within the scope of protection of the present disclosure.

It is worth noting that various objects here not only refer to virtual objects with regular geometric shapes such as spheres, cylinders and cubes, but also include virtual objects with complex geometric features (such as shapes with sharp features and concave shapes). In addition, the virtual object can be a rigid body or a deformable body, both of which are within the scope of protection of the present disclosure.

The contact processing system for virtual hand force interaction proconfigurationd in this embodiment has the following advantages.

1. The cone frustum model used by the virtual hand model in this system is conducive to more realistic visualization of the virtual hand, and it is convenient to implement the collision detection algorithm and the collision response algorithm between the virtual finger and the virtual object, so as to realize efficient and stable contact processing.

2. The proconfigurationd cone frustum-sphere collision detection algorithm can accurately and efficiently determine the contact state between the side edge of the virtual finger and the virtual object, and can be suitable for complex contact types, such as multi-point/multi-area sliding contact, concave contact, etc.

3. The proconfigurationd cone frustum-sphere collision response algorithm can accurately constrain the side edge of the optimized and solved graphic virtual finger on the surface of the virtual object, effectively prevent the virtual finger from being penetrated into the virtual object, and can be well suitable to the constraint optimization of complex contact (multi-point/multi-area sliding contact, concave contact, etc.).

4. The proconfigurationd endpoint contact processing method can effectively prevent the virtual fingertip from being suspended on the surface of the object for a certain distance or being penetrated into the surface of the virtual object in the interaction process, and well support fingertip operations, such as fingertips sliding on the surface of the object, fingertip pinching between two fingers, etc.

5. The proconfigurationd contact processing method for virtual hand force interaction can effectively calculate the contact force of various contact types (single point contact, multi-point contact, etc.) involved in virtual hand interaction, including a normal contact force and a tangential contact force.

6. The proconfigurationd contact processing method for virtual hand force interaction can accelerate the methods involved in contact processing, such as collision detection, collision response, endpoint contact processing and contact force calculation, using a parallel processing mode according to the anatomical structure features of human hands, and improve the efficiency of the virtual hand force interaction.

7. The proconfigurationd contact processing method and system for virtual hand force interaction can obtain the updating frequency of force interaction of 1 kHz without the acceleration of a graphics card, and can be used for low-cost development of the virtual hand interaction application systems such as games and entertainment.

In this specification, various embodiments are described in a progressive way. The differences between each embodiment and other embodiments are highlighted, and the same and similar parts of various embodiments can be referred to each other.

The above embodiments are provided only for the purconfiguration of describing the present disclosure, and are not intended to limit the scope of the present disclosure. The scope of the present disclosure is defined by the appended claims. Various equivalent substitutions and modifications made without departing from the spirit and principle of the present disclosure should be included in the scope of the present disclosure.

What is claimed is:

1. A contact processing method for virtual hand force interaction, comprising:
simulating a real hand by using an articulated cone frustum to obtain a virtual hand, wherein the articulated cone frustum comprises a plurality of cone frustums, and each of the cone frustums simulates a finger knuckle of the real hand; a metacarpophalangeal joint and two interphalangeal joints each are simulated by a sphere; the virtual hand further comprises a plurality of hemispheres, each of the hemispheres is located on a cone frustum simulating a distal finger knuckle, and used to simulate a fingertip of the real hand;
simulating an object by using a sphere-tree model to obtain a virtual object, wherein the virtual object comprises a plurality of numbered spheres;
obtaining a configuration of the real hand of a user;
driving, by using the configuration of the real hand, the virtual hand, which is called a haptic hand;
displaying the haptic hand in a virtual environment to obtain a graphic hand, and displaying the virtual object in the virtual environment;
constructing a cone frustum-sphere contact determination condition:
$${\vert OC \vert}_{j}^{2} - {( \frac{{R}_{j}}{cos α} + {k}_{j} * ( {r}_{1} - {r}_{2} ) + {r}_{2} )}^{2} \underline{<} 0 , j = 1 , 2 , … , M and \\ - \frac{{R}_{j}}{\vert DE \vert} \leq k \leq 1 + \frac{{R}_{j}}{\vert DE \vert} ,$$
wherein |OC|ⱼ is a distance from a center of a sphere numbered j in the virtual object to a central axis l of a cone frustum in the graphic hand, Rⱼ is a radius of the sphere numbered j in the virtual object, M is a number of spheres to be detected in the virtual object,
$${k}_{j} = \frac{\vec{{C}_{j} E}}{\vec{DE}} ,$$
Cⱼ represents a foot point of a perpendicular from the center of the sphere numbered j in the virtual object to the central axis l, E and D represent centers of upper and lower surfaces of the cone frustum in the graphic hand, respectively, α represents an included angle between a side edge of the cone frustum in the graphic hand and the central axis thereof, r₂ and r₁ represent radii of the upper and lower surfaces of the cone frustum in the graphic hand, respectively;
according to graphic hand configuration, virtual object configuration, and the cone frustum-sphere contact determination condition, obtaining information of a collision sphere in contact with a side edge of a finger of the graphic hand, wherein the information of the collision sphere comprises a collision sphere number, a sphere center coordinate of the collision sphere and a sphere radius of the collision sphere; the collision sphere is a sphere in the virtual object in contact with the graphic hand; the side edge of the finger of the graphic hand is a side edge of a cone frustum simulating a finger knuckle of the finger; the graphic hand configuration is used for graphic display;
with θ_{1g}^{t}, θ_{2g}^{t} and θ_{3g}^{t} representing a metacarpophalangeal joint angle, a proximal interphalangeal joint angle and a distal interphalangeal joint angle of each finger of the graphic hand, respectively, according to the graphic hand configuration and the information of the collision sphere where the graphic hand is in contact with the virtual object, constructing a non-penetration contact constraint between the side edge of the finger of the graphic hand and the virtual object as follows:
$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N ,$$
wherein N is a number of spheres in the virtual object which are in contact with virtual fingers of the graphic hand; according to the non-penetration contact constraint between the cone frustums and the spheres, performing optimization on three joint angles θ_{1g}^{t}, θ_{2g}^{t} and θ_{3g}^{t} of each finger of the graphic hand as a whole under a non-penetration contact constraint set, and solving to obtain joint angle information of the finger of the graphic hand that is not penetrated into the virtual object;
according to the joint angle information of the finger of the graphic hand and a formula Fᵢ=Gᵢ·n·|P_{ig}−Pᵢₕ|, calculating normal force Fᵢ of an i-th collision sphere in contact with a corresponding virtual finger, wherein Gᵢ is a 3×3 stiffness matrix, n represents a unit vector of \vec{OᵢPᵢ}, Oᵢ represents a center of a i-th collision sphere, Pᵢ represents a contact point between the i-th collision sphere and a side edge of the virtual finger, and |P_{ig}−Pᵢₕ| is a length of a line segment between a point Pᵢ on the graphic hand and a corresponding position point P′ᵢ on the haptic hand.

2. The contact processing method according to claim 1, wherein in determining contact between the graphic hand and the virtual object:
a graphic hand configuration is a graphic hand configuration at a previous moment;
a cross-sectional radius of a cone frustum of each finger knuckle of the graphic hand is increased by Δr;
a radius of a hemisphere of each finger joint of the graphic hand is increased by Δr;
a graphic hand obtained by above changes is used to determine the contact between the graphic hand and the virtual object, and a collision sphere obtained according to the cone frustum-sphere contact determination condition and a sphere-sphere contact determination condition is used to construct the non-penetration contact constraint set.

3. The contact processing method according to claim 1, wherein while constructing the non-penetration contact constraint
$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N$$
for a distal finger knuckle of each finger, the method further comprises:
if the collision sphere is in contact with the hemisphere simulating the fingertip, constructing a non-penetration contact constraint between the sphere and the hemisphere: |OC|ᵢ²−(Rᵢ+r₂)²≥0, and adding the contact constraint to the non-penetration contact constraint set for optimizing finger joint angles of the graphic hand.

4. The contact processing method according to claim 1, wherein after calculating the normal force Fᵢ of the i-th collision sphere in contact with the corresponding virtual finger according to the formula Fᵢ=Gᵢ·n·|P_{ig}−Pᵢₕ|, the method further comprises:
calculating a friction force in a sliding process of the virtual hand by using a formula fᵢ=u·nᵢ·|Fᵢ|, wherein fᵢ represents a friction force at the i-th collision sphere, u represents a dynamic friction coefficient, and nᵢ is a normal vector of a relative motion between the i-th collision sphere and the virtual finger.

5. A contact processing system for virtual hand force interaction, comprising:
a virtual hand construction module, configured to:
simulate a real hand by using an articulated cone frustum to obtain a virtual hand, wherein the virtual hand comprises a plurality of cone frustums, each of the cone frustums simulates a finger knuckle of the real hand; a metacarpophalangeal joint and two interphalangeal joints each are simulated by a sphere; the virtual hand further comprises a plurality of hemispheres, each of the hemispheres is located on a cone frustum simulating a distal finger knuckle, and used to simulate a fingertip of the real hand;
simulate an object by using a sphere-tree model to obtain a virtual object, wherein the virtual object comprises a plurality of numbered spheres;
obtain a configuration of the real hand of a user;
drive, by using the configuration of the real hand, the virtual hand, which is called a haptic hand; and
display the haptic hand in a virtual environment to obtain a graphic hand, and display the virtual object in the virtual environment;
a cone frustum-sphere collision detection module, configured to:
construct a cone frustum-sphere contact determination condition:
$${\vert OC \vert}_{j}^{2} - {( \frac{{R}_{j}}{cos α} + {k}_{j} * ( {r}_{1} - {r}_{2} ) + {r}_{2} )}^{2} \underline{<} 0 , j = 1 , 2 , … , M and \\ - \frac{{R}_{j}}{\vert DE \vert} \leq k \leq 1 + \frac{{R}_{j}}{\vert DE \vert} ,$$
wherein |OC|ⱼ is a distance from a center of a sphere numbered j in the virtual object to a central axis l of a cone frustum in the graphic hand, Rⱼ is a radius of the sphere numbered j in the virtual object, M is a number of spheres to be detected in the virtual object,
$${k}_{j} = \frac{\vec{{C}_{j} E}}{\vec{DE}} ,$$
Cⱼ represents a foot point of a perpendicular from the center of the sphere numbered j to the virtual object on the central axis l, E and D represent centers of upper and lower surfaces of the cone frustum in the graphic hand, respectively, α represents an included angle between a side edge of the cone frustum in the graphic hand and the central axis thereof, r₂ and r₁ represent radii of the upper and lower surfaces of the cone frustum in the graphic hand, respectively; and
according to graphic hand configuration, virtual object configuration, and the cone frustum-sphere contact determination condition, obtain information of a collision sphere in contact with a side edge of a finger of the graphic hand, wherein the information of the collision sphere comprises a collision sphere number, a sphere center coordinate of the collision sphere and a sphere radius of the collision sphere; the collision sphere is a sphere in the virtual object in contact with the graphic hand; the side edge of the finger of the graphic hand is a side edge of a cone frustum simulating a finger knuckle of the finger; the graphic hand configuration is used for graphic display;
a cone frustum-sphere collision response module, configured to:
with θ_{1g}^{t}, θ_{2g}^{t} and θ_{3g}^{t} representing a metacarpophalangeal joint angle, a proximal interphalangeal joint angle and a distal interphalangeal joint angle of each finger of the graphic hand, respectively, according to the graphic hand configuration and the information of the collision sphere where the graphic hand is in contact with the virtual object, construct a non-penetration contact constraint between the side edge of the finger of the graphic hand and the virtual object as follows:
$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N ,$$
wherein N is a number of spheres in the virtual object which are in contact with virtual fingers of the graphic hand; according to the non-penetration contact constraint between the cone frustums and the spheres, perform optimization on three joint angles θ_{1g}^{t}, θ_{2g}^{t} and θ_{3g}^{t} of each finger of the graphic hand as a whole under a non-penetration contact constraint set, and solve to obtain joint angle information of the finger of the graphic hand that is not penetrated into the virtual object; and
a contact force calculation module, configured to:
according to the joint angle information of the finger of the graphic hand and a formula Fᵢ=Gᵢ·n·|P_{ig}−Pᵢₕ|, calculate normal force Fᵢ of an i-th collision sphere in contact with a corresponding virtual finger, wherein Gᵢ is a 3×3 stiffness matrix, n represents a unit vector of \vec{OᵢPᵢ}, Oᵢ represents a center of a i-th collision sphere, Pᵢ represents a contact point between the i-th collision sphere and a side edge of the virtual finger, and |P_{ig}−Pᵢₕ| is a length of a line segment between a point Pᵢ on the graphic hand and a corresponding position point P′ᵢ on the haptic hand.

6. The contact processing system according to claim 5, wherein in determining contact between the graphic hand and the virtual object:
the cone frustum-sphere collision detection module further comprises following features that:
a graphic hand configuration is a graphic hand configuration at a previous moment;
a cross-sectional radius of a cone frustum of each finger knuckle of the graphic hand is increased by Δr;
a radius of a hemisphere of each finger joint of the graphic hand is increased by Δr;
a graphic hand obtained by above changes is used to determine the contact between the graphic hand and the virtual object, and a collision sphere obtained according to the cone frustum-sphere contact determination condition and a sphere-sphere contact determination condition is used to construct the non-penetration contact constraint set.

7. The contact processing system according to claim 5, further comprising: an endpoint contact processing module, configured to:
while constructing the non-penetration contact constraint
$${\vert OC \vert}_{i}^{2} - {( \frac{{R}_{i}}{cos α} + {k}_{i} * ( {r}_{1} - {r}_{2} ) + {r}_{2} )}^{2} \geq 0 , i = 1 , 2 , … , N$$
for a distal finger knuckle of each finger,
if the collision sphere is in contact with the hemisphere simulating the fingertip, construct a non-penetration contact constraint between the sphere and the hemisphere: |OC|ᵢ²−(Rᵢ+r₂)²≥0, and add the constraint to the non-penetration contact constraint set for optimizing finger joint angles of the graphic hand;
if the collision sphere is not in contact with the hemisphere simulating the fingertip, only construct a cone frustum-sphere contact constraint.

8. The contact processing system according to claim 5, wherein after calculating the normal force Fᵢ of the i-th collision sphere in contact with corresponding virtual finger according to the formula Fᵢ=Gᵢ·n·|P_{ig}−Pᵢₕ|,
the system further calculates a friction force in a sliding process of the virtual hand by using a formula fᵢ=u·nᵢ·|Fᵢ|, wherein fᵢ represents a friction force at the i-th collision sphere, u represents a dynamic friction coefficient, and nᵢ is a normal vector of a relative motion between the i-th collision sphere and the virtual finger.

9. The contact processing system according to claim 5, wherein when palm interaction is involved, palm configuration of the graphic hand is optimized, finger configuration of the graphic hand is obtained by matrix transformation, and according to the finger configuration of the graphic hand and the virtual object configuration, the joint angle information of the finger of the graphic hand that is not penetrated into the virtual object is optimized and solved by using the cone frustum-sphere collision detection module, the cone frustum-sphere collision response module and the endpoint contact processing module.

10. The contact processing system according to claim 5, wherein when multi-finger interaction is processed, a parallel processing mode is used.
